(19) United States
(12) Patent Application Publication
(10) Pub. No.: US 2024/0375595 A1
(43) Pub. Date: Nov. 14, 2024

(54) ARTICULATING CAMERA ASSEMBLY

(71) Applicant: Howe & Howe Inc., Waterboro, ME (US)

(72) Inventors: Forrest Joel Tripp, East Waterboro, ME (US); Matthew Thomas Standiford, Towson, MD (US); Caroline Ruby Bills, Windham, ME (US); Anthony Victor Castro, Cape Elizabeth, ME (US)

(21) Appl. No.: 18/660,412

(22) Filed: May 10, 2024

Related U.S. Application Data
(60) Provisional application No. 63/466,184, filed on May 12, 2023.

(51) Int. Cl. B60R 11/04; B60R 11/00; H04N 23/51; H04N 23/90

(52) U.S. Cl. CPC B60R 11/04; H04N 23/51; H04N 23/90; B60R 2011/004; B60R 2011/0043; B60R 2011/0082; B60R 2011/0085

(57) ABSTRACT

An articulating camera assembly for a vehicle includes a housing, a set of cameras attached to the housing, and a hinge that couples the housing to the vehicle. The hinge is constructed and arranged to enable rotation of the housing between a deployed position in which the set of cameras extends at least partially outside the vehicle and a stowed position in which the set of cameras is retracted within the vehicle. Embodiments are directed to an articulating camera assembly, a vehicle that includes an articulating camera assembly, and a method of operating an articulating camera assembly.

### CROSS-REFERENCE TO RELATED APPLICATIONS

This application claims the benefit of U.S. Provisional Patent Application No. 63/466,184, filed May 12, 2023, the contents and teachings of which are incorporated by reference herein in their entirety.

### BACKGROUND

This invention relates generally to the field of vehicles, and more particularly to mounting and protecting cameras provided on ground vehicles.

Ground vehicles, manned and unmanned, require the operator and/or operating system to have situational awareness of the surrounding environment. Cameras of various types (visual, IR, etc.) are mounted to the extremities of vehicles to provide this situational awareness.

Cameras used in vehicles are typically fixed in position, e.g., either placed on an outer surface of a vehicle or set within the vehicle, where they can image vehicle surroundings through a transparent aperture, such as a window.

### SUMMARY

We have observed that there is a trade-off between camera field of view and camera packaging. In general, the farther outside a vehicle envelope a camera is placed, the better the field of view visualized by the camera. But placing a camera outside the vehicle envelope poses a risk of impact with obstacles in the environment. Shrouds or cages can be used to protect the camera, but these approaches increase vehicle profile, e.g., in length, width, and/or height. Meanwhile, keeping the vehicle envelope as small as possible increases mobility in certain environments, such as forests. In addition to the above, vehicle envelopes can be restricted by certain requirements, such as transport of a vehicle in a cargo container, helicopter, or ship. In cases where a vehicle is too large for transport due to cameras located at the extremes of a vehicle profile, it may be necessary for cameras to be removed. What is needed, therefore, is a solution that allows a camera to have a large field of view while also minimizing the impact of the camera on the vehicle envelope.

The above need is addressed at least in part by an improved technique that allows a camera to extend outside the envelope of a vehicle when in use, thus affording a wide field of view, but allows the camera to retract into the vehicle when the camera comes into contact with obstacles or at any other desired time (e.g., transport), such that the camera may be stowed safely within the vehicle while reducing the vehicle envelope.

Certain embodiments are directed to an articulating camera assembly for a vehicle. The articulating camera assembly includes a housing, a set of cameras attached to the housing, and a hinge that couples the housing to the vehicle. The hinge is constructed and arranged to enable rotation of the housing between a deployed position in which the set of cameras extends at least partially outside the vehicle and a stowed position in which the set of cameras is retracted within the vehicle.

In some examples, the housing is a coupled to a side of the vehicle, and the hinge is oriented vertically such that the housing is enabled to swing laterally about the hinge between the deployed position and the stowed position.

In some examples, the articulating camera assembly further includes a spring constructed and arranged to bias the housing to the deployed position and enabling the housing to assume the stowed position upon application of an external force to the housing.

In some examples, the articulating camera assembly further includes a latch coupled between the housing and the vehicle for selectively holding the housing in the stowed position.

In some examples, the articulating camera assembly further includes an actuator constructed and arranged to rotate the housing the between the deployed position and the stowed position.

In some examples, the housing has a front edge and a rear edge, the front edge being closer to a front of the vehicle than the rear edge. The hinge is positioned closer to the front edge than to the rear edge, such that the housing is enabled to swing about the hinge from the deployed position to the stowed position responsive to the housing encountering an obstacle while the vehicle is driving forward.

In some examples, the hinge is disposed at the front edge of the housing.

In some examples, the spring is a torsion spring axially aligned with the hinge.

In some examples, the articulating camera assembly further includes a first L-shaped bracket attached to the vehicle. The first articulating camera assembly has a front-facing member and an outward-facing member. The housing includes a second L-shaped bracket having a rear-facing member and an inward-facing member. The second L-shaped bracket is fixedly attached to the set of cameras, and the inward-facing member of the second L-shaped bracket is rotatably connected, via the hinge, to the front-facing member of the first L-shaped bracket.

In some examples, the spring is disposed between the outward-facing member of the first L-shaped bracket and the second L-shaped bracket.

In some examples, the articulating camera assembly further includes a magnetic closure disposed between the outward-facing member of the first L-shaped bracket and the rear-facing member of the second L-shaped bracket.

In some examples, the articulating camera assembly further includes an outwardly-bowing horizontal rim having a fixed position relatively to the set of cameras and defining a farthest outward extent of the articulating camera assembly in the deployed position.

In some examples, the housing is constructed and arranged to retract toward the stowed position responsive to the housing encountering a stationary obstacle both while the vehicle is driving forward and while the vehicle is driving backwards.

Other embodiments are directed to a vehicle that includes an articulating camera assembly disposed on an exterior surface of the vehicle. The articulating camera assembly includes a housing, a set of cameras attached to the housing, and a hinge that couples the housing to the vehicle. The hinge is constructed and arranged to enable rotation of the housing between a deployed position in which the set of cameras extends at least partially outside the exterior surface and a stowed position in which the set of cameras is retracted within the exterior surface.

In some examples, the articulating camera assembly further includes a spring constructed and arranged to bias the housing to the deployed position and enabling the housing to assume the stowed position upon application of an external force to the housing.

In some examples, the housing has a front edge and a rear edge. The front edge is closer to a front of the vehicle than the rear edge, and the hinge is disposed at a front edge of the housing.

In some examples, the articulating camera assembly further includes a first L-shaped bracket attached to the vehicle. The first L-shaped bracket has a front-facing member and an outward-facing member. The housing includes a second L-shaped bracket having a rear-facing member and an inward-facing member. The second L-shaped bracket is fixedly attached to the set of cameras, and the inward-facing member of the second L-shaped bracket is rotatably connected, via the hinge, to the front-facing member of the first L-shaped bracket.

Still further embodiments are directed to a method of an articulating camera assembly in a vehicle. The articulating camera assembly includes a housing, a set of cameras attached to the housing, and a hinge that couples the housing to the vehicle. The hinge is constructed and arranged to enable rotation of the housing between a deployed position in which the set of cameras extends at least partially outside the vehicle and a stowed position in which the set of cameras is retracted within the vehicle. The method includes applying a biasing force that biases the housing to the deployed position, moving the vehicle forward, and, upon the housing encountering an obstacle while the vehicle is moving forward, enabling rotation of the housing against the biasing force from the deployed position toward the stowed position.

In some examples, the method further includes, after the housing clears the obstacle while the vehicle is moving forward, restoring the housing to the deployed position in compliance with the biasing force.

In some examples, the method further includes, upon the housing encountering a second obstacle while the vehicle is moving backwards, enabling rotation of the housing against the biasing force from the deployed position toward the stowed position.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a perspective view of an articulating camera assembly in a vehicle in accordance with a first embodiment, shown in a deployed position.

FIG. 2 is a perspective view of the articulating camera assembly of FIG. 1, shown in a stowed position.

FIG. 3 is a perspective view of an articulating camera assembly in a vehicle in accordance with a second embodiment, shown in a deployed position.

FIG. 4 is a perspective view of the articulating camera assembly of FIG. 3, shown in a stowed position.

FIG. 5 is a perspective view of the articulating camera assembly of FIGS. 3 and 4, shown apart from the vehicle in the deployed position.

FIG. 6 is a perspective view of the articulating camera assembly of FIGS. 3 and 4, shown apart from the vehicle in the stowed position.

FIG. 7 is a rear perspective view of the articulating camera assembly of FIGS. 3 and 4, shown apart from the vehicle in the deployed position.

FIG. 8 is a rear perspective view of the articulating camera assembly of FIGS. 3 and 4, shown apart from the vehicle in the stowed position.

FIG. 9 is an isometric view of an example vehicle in which the articulating camera assembly according to any of the above-described embodiments is provided.

FIG. 10 is a flowchart showing an example method of operating an articulating camera assembly in a vehicle.

### DETAILED DESCRIPTION

Embodiments of the improved technique will now be described. One should appreciate that such embodiments are provided by way of example to illustrate certain features and principles but are not intended to be limiting.

An improved technique allows a camera to extend outside the envelope of a vehicle when in use, thus affording a wide field of view, but allows the camera to retract into the vehicle when the camera comes into contact with obstacles or at any other desired time (e.g., transport), such that the camera may be stowed safely within the vehicle while reducing the vehicle envelope.

According to improvements hereof, a camera is mounted to a bracket, frame, or other housing, which is mounted to a hinge. The camera and the housing together form a camera assembly. The hinge is fixed to the vehicle, such as to a chassis or body of the vehicle, or to a bracket attached to the vehicle, allowing the camera assembly to articulate about the hinge. The extremes of articulation include a deployed position and a stowed position. The “deployed” position provides a desired field of view, and a “stowed” position provides desired vehicle envelope.

In some examples, the hinge may be spring loaded. For example, a spring (e.g., torsion spring, helical spring, gas spring, etc.) may be provided to bias the camera assembly to the deployed position, but to allow the camera assembly to rotate back against the spring force, toward to the stowed position, when the camera assembly encounters an obstacle. The disclosed technique thus allows the housing to articulate when an obstacle, such as a branch, scrapes along the vehicle and folds in the camera assembly, e.g., against the spring force, with the camera assembly springing back to the deployed position once it clears the obstacle.

In some examples, a latch may be installed to hold the camera assembly in the stowed position. The latch prohibits the camera from protruding out when the vehicle operates in tight spaces, such as when loading the vehicle into a helicopter. The latch may be realized using a conventional latch with a T-handle. Alternatively, the latch could be a push-to-close latch (like a gas cap cover) or a magnetically engaged latch.

In some examples, no spring or latch may be installed, but instead an actuator may be used to intentionally actuate the camera, e.g., under electronic control (local or remote). The actuator may be an electromechanical actuator or a pneumatic actuator, e.g., one driven by compressed air or fluid.

In some examples, a combination of a spring and an actuator may be used to ensure the camera is protected from obstacles (passive movement) while still being able to be intentionally actuated (active movement). For example, an actuator could be coupled to the camera assembly via a spring (or other compliant component), which normally does not substantially deform when moved by the actuator but does deform in response to forcible contact with an obstacle.

In some examples, the hinge is positioned at a front-most edge of the housing (closest to a front of the vehicle) and substantially on a same plane as an adjacent outer surface of the vehicle. When used in connection with a spring that biases the camera assembly to the deployed position, this arrangement allows the camera assembly to rotate back, toward the stowed position, when the vehicle drives forward and encounters an obstacle that pushes against the camera assembly. The hinge could be placed on other edges of the housing, however, depending on intended use.

In other examples, the hinge is attached to a mid or back portion of the housing and is recessed within the vehicle. With this arrangement, the camera assembly can move from the deployed position toward the stowed position regardless of whether the vehicle is moving forward or backward when encountering an obstacle. Also, the hinge in this arrangement may be placed such that it does not block any portion of the field of view of the camera(s).

In some examples, the camera assembly includes a single camera. In other examples, the camera assembly includes multiple cameras, such as one facing in a first direction, one facing in a second direction, and one facing in a third direction. The cameras may be optical cameras, infrared cameras, or any type or types of cameras, in any combination.

In some examples, one or more rims are provided for protecting the camera(s) from obstacles in the environment. For example, the rims extend outwardly beyond the camera lenses, such that the rims rather than the lenses take contact forces from obstacles in the environment.

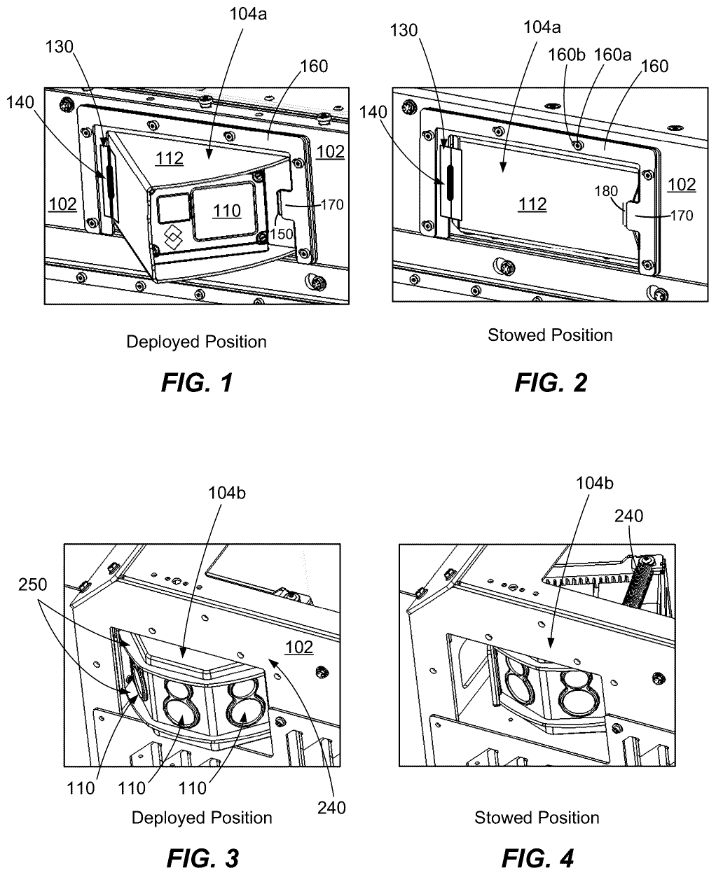

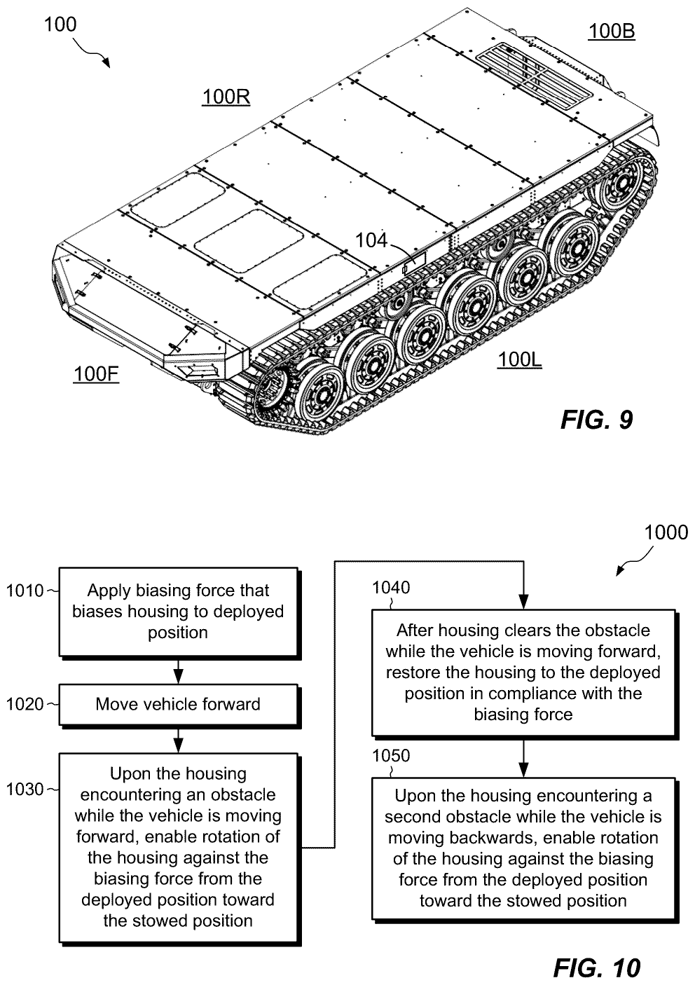

FIGS. 1 and 2 show an example articulating camera assembly 104a according to a first embodiment. Here, the articulating camera assembly 104a is installed within an exterior surface 102 of a vehicle 100, which is shown in FIG. 9. For example, the exterior surface may be a side surface of the vehicle 100, such as a left side or a right side. FIGS. 1 and 2 both show a left side 100L of the vehicle, with the front 100F of the vehicle being to the left and the back 110B of the vehicle being to the right.

The articulating camera assembly 104a includes one or more cameras 110 attached to and disposed within a housing 112. The housing 112 is attached to the exterior surface 102 of the vehicle via a hinge 130, which in the depicted example is on the same plane as the exterior surface 102. The hinge 130 enables the housing 112 to swing between a deployed position (FIG. 1), in which the camera 110 has an unobstructed view of its surroundings, and a stowed position (FIG. 2) in which the camera 110 is fully retracted within the vehicle, such that neither the camera 110 nor the housing 112 adds substantially to the envelope of the vehicle. Although the hinge 130 is shown as an external component that is visible from outside of the vehicle 100, this is just an example. As an alternative, the hinge 140 may be located inside the vehicle, where it is not necessarily visible from the outside. In such an arrangement, the hinge 140 may be realized with a bolt (or a pair of coaxial bolts), which pass through holes in upper and lower lefthand parts of the housing 112, allowing rotation of the housing 112 in the manner shown but about an axis that is slightly recessed within the vehicle 100.

In an example, a spring 140 biases the housing 112 to the deployed position (FIG. 1). In this arrangement, the housing 112 remains deployed unless acted upon by an external force. For example, if the vehicle 100 is moving forward and scrapes against the branch of a tree, the branch can push the housing 112 closed (to the stowed position), i.e., against a biasing force imparted by the spring 140. Once the vehicle clears the branch, the housing 112 springs back to the deployed position, in compliance with the spring force. In the example shown, the spring 140 is a torsion spring mounted along an axis of the hinge 130. Other types of springs and spring connection arrangements can be used, however. For example, a helical spring may be placed inside the vehicle for biasing the housing 112 to the deployed position. The spring may be oriented horizontally, for example, with one end attached to a back portion of the housing 112 and another end attached to a body or frame of the vehicle to the right of the housing (from the perspective shown).

In some arrangements, the articulating camera assembly 104a may include a magnetic retainer, which firmly holds the housing 112 in the deployed position. Even though the spring 140 biases the housing open, the housing 112 can still be jostled by vibrations when the vehicle is underway. The magnetic retainer helps to prevent this jostling so that the camera 110 can work more effectively. For example, a magnet 150 may be attached to a back wall of the housing 112 and a steel tab 170 may extend from the vehicle 100, e.g., from a frame 160 attached the vehicle 100. When the housing 112 opens to the deployed position, the magnet 150 attracts and makes contact with the tab 170 (FIG. 1), holding the housing 112 firmly open.

In an example, the tab 170 can also serve as a latch for keeping the housing closed, i.e., in the stowed position. For example, the tab 170 may extend from a frame 160, which is attached to the side of the vehicle 100 via screws 160a that extend through horizontally slotted holes 160b. The screws 160a may be loosened, and the frame 160 may be shifted to the right. The housing 112 may then be closed, as shown in FIG. 2. With the housing 112 held closed, the frame 160 may be shifted back to the left, capturing an edge 180 of the housing behind the tab 170. The screws 160a may then be tightened. This feature may be particularly helpful during transport, where it may be desirable to minimize vehicle envelope.

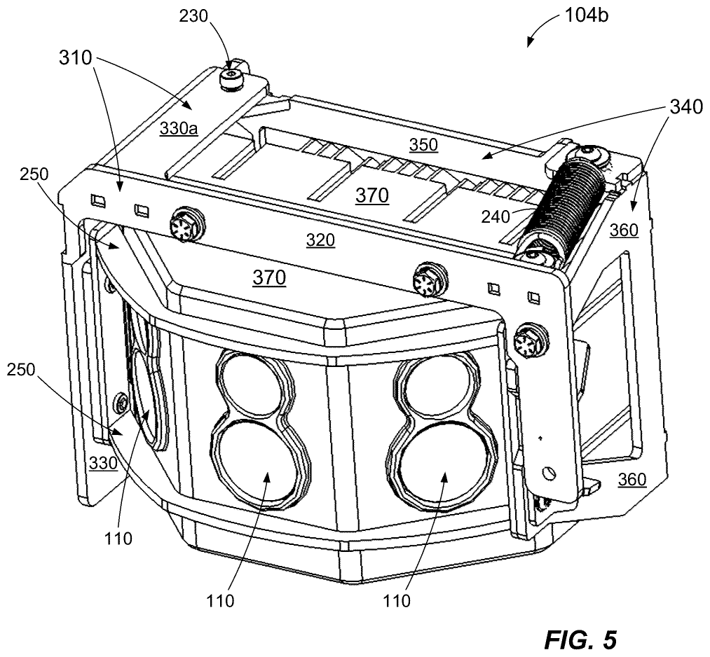

FIGS. 3 and 4 show an example articulating camera assembly 104b according to a second embodiment in both a deployed position (FIG. 3) and a stowed position (FIG. 4). As with the first articulating camera assembly 104a, the second articulating camera assembly 104b may also be installed within an exterior surface 102 of a vehicle 100, such as the left side, as shown. In this example, however, a hinge 230 (FIG. 5) is recessed within the vehicle, rather than being on the same plane as the exterior surface 102. The recessed hinge 30 avoids blocking the view of the rear-facing camera and thus affords maximum visibility.

The articulating camera assembly 104b also includes at least one outwardly-bowing horizontal rim 250. Two such rims 250 are shown, one above the cameras 110 and one below. The rims 250 define an outermost extent of the articulating camera assembly 104b and thus provide protection for the cameras 110. If the vehicle encounters a branch or other obstacle while driving, for example, the rims 250 would make contact with the branch rather than the cameras. The outwardly-bowing shape of the rims 250 also facilitates retraction of the articulating camera assembly 104b when it encounters an obstacle, both when the vehicle is driving forward and when the vehicle is driving backwards.

In an example, the hinge 230 is realized as a bolt (or multiple coaxial bolts) that extend vertically and are loosely applied, such that rotation about the bolt can be achieved. Although a torsion spring may be used in this embodiment, an alternative is a helical spring 240, as shown. Further details of this second embodiment will become evident from FIGS. 5-8.

FIG. 5 shows the articulating camera assembly 104b apart from the vehicle 100 in the deployed position. Here, the articulating camera assembly 104b includes a first L-shaped bracket 310, a second L-shaped bracket 340, and a camera module 370. The first L-shaped bracket 310 is constructed and arranged to attach to the exterior surface 102 of the vehicle, e.g., using screws, bolts, rivets, or the like, and includes an outward-facing member 320 and a front-facing member 330 (The terms front, rear, inward, and outward are relative to the vehicle). The members 320 and 330 may be integral or attached together. The front-facing member 330 has an upper tab 330a, which facilitates insertion of the hinge 230 (e.g., a bolt).

The second L-shaped bracket 340 attaches to the camera module 370, which includes the cameras 110, and provides a housing of the articulating camera assembly 104b. The second L-shaped bracket 340 includes an inward-facing member 350 and a rear-facing member 360. The members 350 and 360 may be integral or attached together.

It is thus seen that the hinge 230 rotatably attaches the front-facing member 330 of the first L-shaped bracket 310 to the inward-facing member 350 of the second L-shaped bracket 340. Also, the spring 240 is placed between the outward-facing member 320 of the first L-shaped bracket 310 and the second L-shaped bracket 340, e.g., at a corner formed between the inward-facing member 350 and the rear-facing member 360.

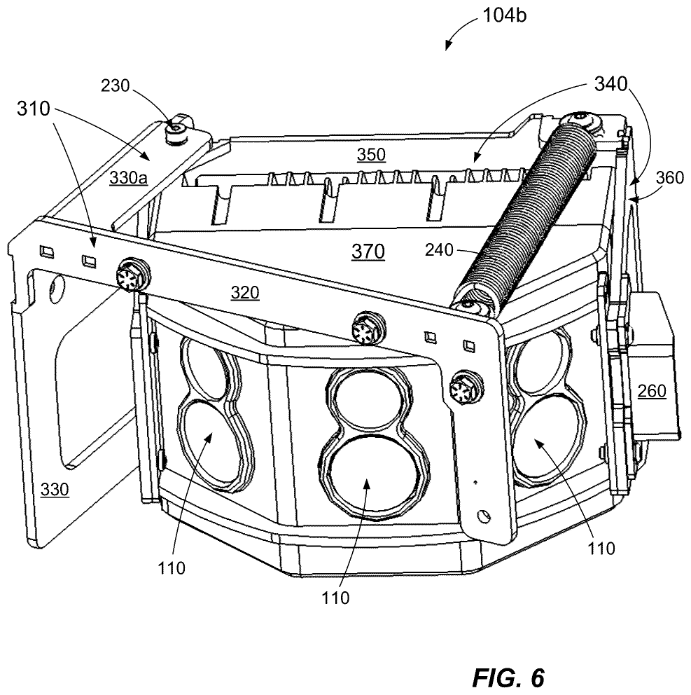

FIG. 6 has a similar perspective to FIG. 5 but shows the articulating camera assembly 104b in the stowed position. Here, the second L-shaped bracket 340 has swung back about the hinge 230 and has placed the spring 240 under tension.

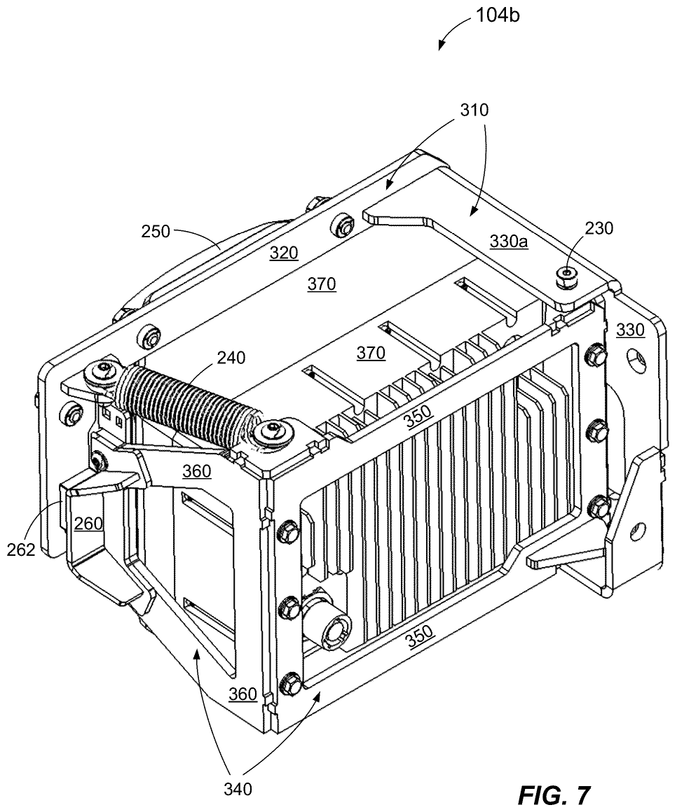

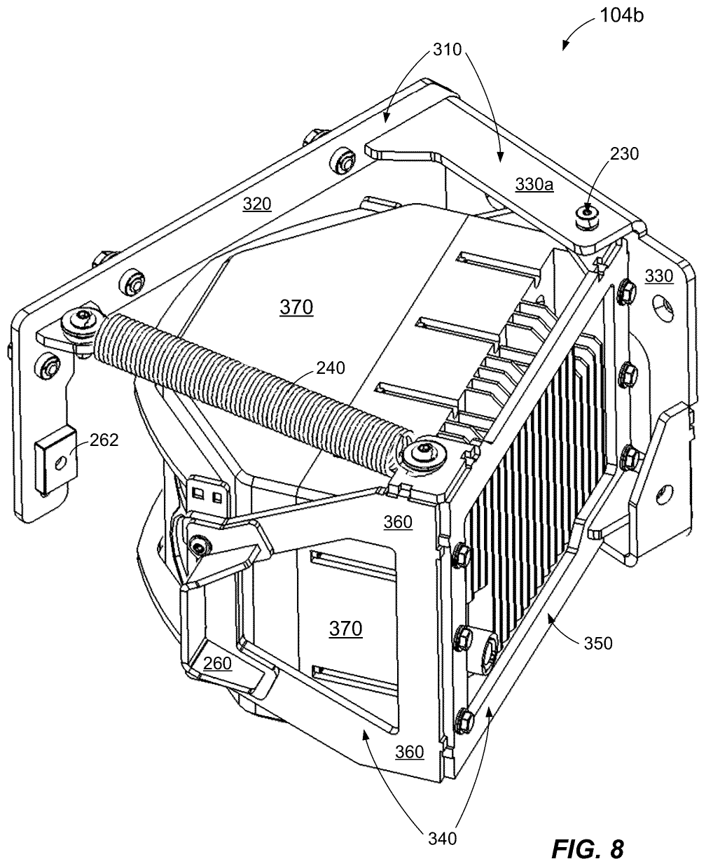

Additional details can be seen from the rear perspective views of FIGS. 7 and 8. FIG. 7 shows the articulating camera assembly 104b in the deployed position, and FIG. 8 shows the articulating camera assembly 104b in the stowed position. As shown, a magnetic closure is formed between the outward-facing member 320 and the rear-facing member 360. For example, a steel flange 260 may be attached to a rear surface of the rear-facing member 360 and a magnet 262 may be attached to an inner surface of the outward-facing member 320. The magnet 262 attracts and holds the flange 260 in the deployed position (FIG. 7) but has no noticeable effect in the stowed position (FIG. 8).

FIG. 9 shows an example vehicle 100 with which embodiments of the improved technique can be practiced. Here, the vehicle 100 is a tracked vehicle that includes one or more articulating camera assemblies 104, such as one articulating camera assembly 104 on the left 100L of the vehicle (as shown) and another articulating camera assembly 104 on the right 100R of the vehicle (not shown). Each articulating camera assembly 104 may be the articulating camera assembly 104a of the first embodiment or the articulating camera assembly 104b of the second embodiment. In addition, the articulating camera assemblies 104 may include features of both embodiments 104a and 104b.

FIG. 10 shows an example method 1000 of operating an articulating camera assembly 104 in a vehicle 100. At 1010, a biasing force is applied that biases the housing of the articulating camera assembly 104 to the deployed position. For example, the biasing force is applied by a spring 140 or 240, which biases the housing 112 or 340 to the deployed position.

At 1020, the vehicle 100 is driven forward. For example, the vehicle 100 may be driven directly or by remote control. The vehicle 100 may be driven through a forest or other area that includes obstacles.

At 1030, upon the housing 112/340 encountering an obstacle while the vehicle is moving forward, rotation of the housing is enabled against the biasing force from the deployed position toward the stowed position. For example, the vehicle 100 may move forward and brush against a tree branch, which strikes the deployed housing 112/340 and pushes it closed against the spring force.

At 1040, the vehicle 100 continues to move forward and the housing 112/340 clears the obstacle (e.g., tree branch), causing the housing to spring back in compliance with the biasing force and restoring the housing to the deployed position.

At 1050, the vehicle 100 may be driven backwards and the housing may strike a second obstacle. If the second embodiment 104b is being used (or if modifications are made to the first embodiment 104a), the housing rotates to the stowed position against the biasing force, once again assuming the deployed position.

An improved technique has been described that allows a camera 110 (or multiple cameras) to extend outside the envelope of a vehicle 100 when in use, thus affording a wide field of view, but allows the camera 110 to retract into the vehicle 100 when the camera comes into contact with obstacles or at any other desired time (e.g., transport), such that the camera may be stowed safely within the vehicle 100 while reducing the vehicle envelope.

Having described certain embodiments, numerous alternative embodiments or variations can be made. For example, although two distinct embodiments have been described, one should appreciate that features of the two embodiments may be combined in any manner that makes technological sense. Thus, features disclosed in connection with either embodiment may be included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

Table of Reference Numerals

| Reference | |
|---|---|
| Numeral | Description |
| 100 | Vehicle |
| 102 | Adjacent outer surface of vehicle |
| 104 | Articulating camera assembly |
| 104a | First embodiment of articulating camera assembly |
| 104b | Second embodiment of articulating camera assembly |
| 110 | Camera |
| 112 | Camera housing (1^{st} embodiment) |
| 130 | Hinge (1^{st} embodiment) |
| 140 | Spring; biases camera assembly open to deployed position |
| | (1^{st} embodiment) |
| 150 | Magnet, e.g., attached to back wall of housing 112 |
| 160 | Frame; moveable left and right via slotted through holes. |
| 160a | Screws; pass through slotted holes. |
| 160b | Slotted holes; allow frame to move left and right |
| 170 | Lip of frame 160 |
| 180 | Edge of housing 112 |
| 230 | Hinge (2^{nd} Embodiment); recessed within vehicle body |
| 240 | Spring (2^{nd} Embodiment); biases camera assembly open to |
| | deployed position. Preferably a single spring is used (not |
| | two as appear in certain figures) |
| 250 | Rim(s); protects camera(s) from contact with obstacles in |
| | environment |
| 260 | Steel flange (for magnetic closure) |
| 262 | Magnet (for magnetic closure) |
| 310 | First L-shaped bracket (2^{nd} embodiment) |
| 320 | Outward-facing member of first L-shaped bracket |
| 330 | Front-facing member of first L-shaped bracket |
| 330a | Upper tab of front-facing member |
| 340 | Second L-shaped bracket (provides housing in second |
| | embodiment) |
| 350 | Inward-facing member of second L-shaped bracket |
| 360 | Rear-facing member of second L-shaped bracket |
| 370 | Camera module |

What is claimed is:

1. An articulating camera assembly for a vehicle, comprising:
a housing;
a set of cameras attached to the housing; and
a hinge that couples the housing to the vehicle, the hinge constructed and arranged to enable rotation of the housing between a deployed position in which the set of cameras extends at least partially outside the vehicle and a stowed position in which the set of cameras is retracted within the vehicle.

2. The articulating camera assembly of claim 1, wherein the housing is a coupled to a side of the vehicle, and wherein the hinge is oriented vertically such that the housing is enabled to swing laterally about the hinge between the deployed position and the stowed position.

3. The articulating camera assembly of claim 2, further comprising a spring constructed and arranged to bias the housing to the deployed position and enabling the housing to assume the stowed position upon application of an external force to the housing.

4. The articulating camera assembly of claim 3, further comprising a latch coupled between the housing and the vehicle for selectively holding the housing in the stowed position.

5. The articulating camera assembly of claim 3, further comprising an actuator constructed and arranged to rotate the housing the between the deployed position and the stowed position.

6. The articulating camera assembly of claim 3, wherein the housing has a front edge and a rear edge, the front edge being closer to a front of the vehicle than the rear edge, and wherein the hinge is positioned closer to the front edge than to the rear edge, such that the housing is enabled to swing about the hinge from the deployed position to the stowed position responsive to the housing encountering an obstacle while the vehicle is driving forward.

7. The articulating camera assembly of claim 6, wherein the hinge is disposed at the front edge of the housing.

8. The articulating camera assembly of claim 7, wherein the spring is a torsion spring axially aligned with the hinge.

9. The articulating camera assembly of claim 3, further comprising a first L-shaped bracket attached to the vehicle, the first L-shaped bracket having a front-facing member and an outward-facing member,
wherein the housing includes a second L-shaped bracket having a rear-facing member and an inward-facing member, the second L-shaped bracket fixedly attached to the set of cameras, and
wherein the inward-facing member of the second L-shaped bracket is rotatably connected, via the hinge, to the front-facing member of the first L-shaped bracket.

10. The articulating camera assembly of claim 9, wherein the spring is disposed between the outward-facing member of the first L-shaped bracket and the second L-shaped bracket.

11. The articulating camera assembly of claim 9, further comprising a magnetic closure disposed between the outward-facing member of the first L-shaped bracket and the rear-facing member of the second L-shaped bracket.

12. The articulating camera assembly of claim 9, further comprising an outwardly-bowing horizontal rim having a fixed position relatively to the set of cameras and defining a farthest outward extent of the articulating camera assembly in the deployed position.

13. The articulating camera assembly of claim 12, wherein the housing is constructed and arranged to retract toward the stowed position responsive to the housing encountering a stationary obstacle both while the vehicle is driving forward and while the vehicle is driving backwards.

14. A vehicle, comprising:
an articulating camera assembly disposed on an exterior surface of the vehicle,
the articulating camera assembly including
a housing;
a set of cameras attached to the housing; and
a hinge that couples the housing to the vehicle, the hinge constructed and arranged to enable rotation of the housing between a deployed position in which the set of cameras extends at least partially outside the exterior surface and a stowed position in which the set of cameras is retracted within the exterior surface.

15. The vehicle of claim 14, wherein the articulating camera assembly further includes a spring constructed and arranged to bias the housing to the deployed position and enabling the housing to assume the stowed position upon application of an external force to the housing.

16. The vehicle of claim 15, wherein the housing has a front edge and a rear edge, the front edge being closer to a front of the vehicle than the rear edge, and wherein the hinge is disposed at a front edge of the housing.

17. The vehicle of claim 15, wherein the articulating camera assembly further includes a first L-shaped bracket attached to the vehicle, the first L-shaped bracket having a front-facing member and an outward-facing member,
wherein the housing includes a second L-shaped bracket having a rear-facing member and an inward-facing member, the second L-shaped bracket fixedly attached to the set of cameras, and
wherein the inward-facing member of the second L-shaped bracket is rotatably connected, via the hinge, to the front-facing member of the first L-shaped bracket.

18. A method of operating an articulating camera assembly in a vehicle, the articulating camera assembly including:
a housing;
a set of cameras attached to the housing; and
a hinge that couples the housing to the vehicle, the hinge constructed and arranged to enable rotation of the housing between a deployed position in which the set of cameras extends at least partially outside the vehicle and a stowed position in which the set of cameras is retracted within the vehicle,
the method comprising:
applying a biasing force that biases the housing to the deployed position;
moving the vehicle forward; and
upon the housing encountering an obstacle while the vehicle is moving forward, enabling rotation of the housing against the biasing force from the deployed position toward the stowed position.

19. The method of claim 18, further comprising, after the housing clears the obstacle while the vehicle is moving forward, restoring the housing to the deployed position in compliance with the biasing force.

20. The method of claim 18 wherein, upon the housing encountering a second obstacle while the vehicle is moving backwards, enabling rotation of the housing against the biasing force from the deployed position toward the stowed position.
